(19) United States
(12) Patent Application Publication
(10) Pub. No.: US 2007/0169368 A1
(43) Pub. Date: Jul. 26, 2007

(54) FILTER BASKET LINER FOR A LAUNDRY DRYER

(75) Inventor: Vincent K. Kim, Newtown, PA (US)

Correspondence Address: GREGORY J. GORE, 70 WEST OAKLAND AVENUE, SUITE 316, DOYLESTOWN, PA, 18901, US

(73) Assignees: Vincent K. Kim, Newtown, PA (US); Lydia Y. Kim, Newtown, PA (US)

(21) Appl. No.: 11/307,114

(22) Filed: Jan. 24, 2006

(51) Int. Cl. F26B 21/06; F26B 11/02

(52) U.S. Cl. 34/82; 34/604

(57) ABSTRACT

A lint filter basket liner for a laundry dryer includes a central area of filter medium including a metal foil border on at least one side edge but preferably on multiple side edges. When placed over the lint filter screen, the liner is held in place by deformation of the foil border around the sides of the filter basket. The border spans a sufficient distance such that it can accommodate a range of filter basket sizes and proportions. The filter medium may consist of any suitable material including fibrous non-woven, a fibrous woven fabric, or a fibrous knitted fabric. The foil border is preferably affixed to the foil medium by an adhesive in which edge portions of the filter medium are laminated between opposing layers of the metal foil.

### FIELD OF THE INVENTION

This invention relates to a laundry dryer having a filter basket positioned in the flow of drying air for removing lint. More specifically, it relates to a filter basket liner which enhances the filtering effect of the filter basket and facilitates the easy removal of lint accumulated on the surface of the filter.

### BACKGROUND OF THE INVENTION AND PRIOR ART

It is well known to provide dryers of different types with filters positioned in the flow of drying air in order to remove dust and lint particles. Some of these filters include a filter basket having a frame and a centrally positioned screen as the filtering medium. The screen is of the appropriate mesh size to remove fine particles of lint and dust without significantly restricting the flow of air. Over time, lint accumulates and will clog the screen unless the lint is manually removed at regular internals. This can be an unpleasant and messy process.

In order to enhance the air filtering and to facilitate the manual removal of accumulated lint, it is also known to utilize an additional removable liner. Such a liner is disclosed for example in U.S. Pat. No. 6,966,126 issued to Baurmann. Baurmann teaches the use of an added fibrous filter element within a hinged filter frame positioned over the filter screen. U.S. Pat. No. 5,974,690 issued to Canada teaches the use of a removable filter for a hair dryer in which a self-adhesive filter cloth is positioned over the hair dryer vent to filter dust and lint.

While the Baurmann removable laundry dryer filter functions adequately, it is relatively difficult to remove from the hinged frame and the filter must be dimensioned precisely to the size of the frame. This precludes the possibility of a generic filter liner sheet that can be used with many different types of dryers. The Canada filter liner is easily removable but requires an adhesive and a removable peel-off layer which creates handling problems and additional waste.

There is therefore a need in the art for a filter liner for a laundry dryer which facilitates the removal of lint from the filter screen and which includes attachment means which will permit one size of filter liner sheet to be used with many different size filter screens.

### SUMMARY OF THE INVENTION

In order to meet the needs in the art for an improved laundry dryer filter liner explained above, the present filter liner sheet has been devised. Specifically, the filter basket liner of the invention comprises a central area of filter medium having a metal foil border on at least one side edge but as will be further described may have a foil border on multiple side edges. When placed over the filter screen, deformation of the foil border around the sides of the filter basket liner is held in filtering position superimposed with the filter screen. The border spans a sufficient distance such that it can accommodate a range of filter basket sizes and proportions. The filter medium of the liner may consist of any suitable material including fibrous non-woven, a fibrous woven fabric, or a fibrous knitted fabric. The foil border is preferably affixed to the filter medium by an adhesive in which edge portions of the filter medium are laminated between opposing layers of metal foil.

In use, the filter basket liner of the invention provides a filtering system which permits a one-size filter liner sheet to be used with different size laundry dryer filter baskets. The liner is securely yet removably held to the filter basket and is easily removed, carrying away accumulated lint and dust with it. The liner and lint are disposed of together. A new liner is then applied over the filter basket screen. This permits the accumulated lint to be removed without being touched by the user. As an enhancement to the invention, the filter medium may be covered with an odorous substance to apply a pleasant scent to the dried laundry.

From the following drawings and description of the preferred embodiment, it will be appreciated by those of skill in the art that the objects of the invention have been achieved. While the present invention will be described with the reference to a specific embodiment, the following description is illustrative of the invention and is not to be construed as limiting the invention. Various modifications to the present invention can be made to the preferred embodiment by those skilled in the art without departing from the true spirit and scope of the invention. It will be noted here that for better understanding like components are designated by the reference numerals throughout the various figures of drawing which follow.

### BRIEF DESCRIPTION OF THE DRAWINGS

FIG. 1 is a top right front isometric view of the invention.

FIG. 2 is a top left front assembly view.

FIG. 3 is a sectional view taken from FIG. 1 as shown in that figure.

### DESCRIPTION OF THE PREFERRED EMBODIMENT

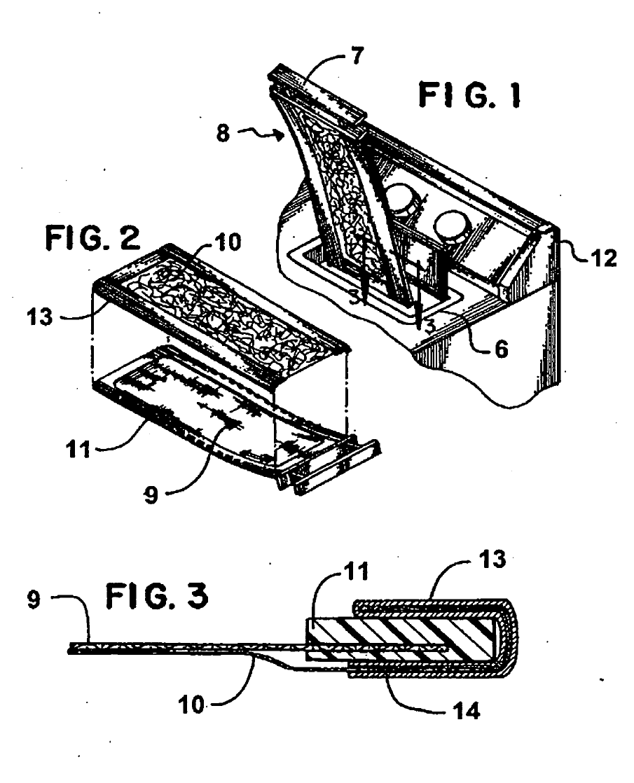

Referring now to FIG. 1, the present invention is shown installed on a typical filter frame 11 which is held in a housing 6 of a laundry dryer 12. The filter frame is positioned in the flow of drying air to remove lint and dust. The frame includes a handle 7 for easy removal from the housing 6. The dryer shown in this figure is an example of but one type of dryer. It should be understood that there are many other dryer types and configurations having different locations and sizes of filter screens to which the present invention can be adapted.

Referring now to FIG. 2, the present invention is shown positioned relative to the filter basket 11 which includes centrally located filtering screen 9. The filter liner of the invention includes a central fibrous filtering medium 10 which in this embodiment is surrounded on three sides by a broad metal foil border 13. The border is of sufficient dimension that the liner may be affixed around the side edges of filter basket frames of varying sizes. The liner is applied to the filter basket simply by placing it over the surface of the basket with the filter medium in alignment with the filter basket screen and then by deforming the metal foil around the side edges of the filter basket frame. The shape memory of the foil which is wrapped around against the backside of the filter frame allow it to hold the liner securely against the filter screen.

Referring now to FIG. 3, the position of the filter medium against the filter screen is depicted. One construction of the filter liner is to apply the metal foil border to the side edges of the filter medium by laminating the filter medium between opposing layers of a folded foil panel 13 using an adhesive 14. As described above, the liner is applied to the filter screen by wrapping the foil around the side edges of the basket frame 11. In the preferred embodiment, the filter medium 10 is preferably covered with an odorous substance so that a pleasant scent is applied to the dried laundry.

It should be understood that there may be other modifications and changes to the present invention that will be obvious to those of skill in the art from the foregoing description, however, the present invention should be limited only by the following claims and their legal equivalents.

1. A filter basket liner comprising, a central area of filter medium having a substantially planar pliable metal foil border along at least one side edge thereof and extending outwardly from said side edge, said metal foil being adapted for affixation to said filter basket by manual deformation of said foil around sides of said basket.

2. The filter liner of claim 1 further described as being a substantially rectangular, flexible sheet.

3. The basket liner of claim 1 wherein said foil border is affixed to said filter medium by an adhesive.

4. The filter basket liner of claim 3 wherein edge portions of the filter medium are laminated between opposing layers of said metal foil.

5. The filter basket liner of claim 1 wherein said filter medium is a sheet of one of the group consisting of fibrous non-woven, a fibrous woven fabric, and a fibrous knitted fabric.

6. A lint filtering system for a laundry dryer, comprising:
a laundry dryer having a housing for holding a filter basket, said filter basket including a filter screen supported by a frame and being positioned in a flow of drying air; and
a filter basket liner including a central area of filter medium having a substantially planar pliable metal foil border along at least one side edge thereof and extending outwardly from said side edge, said liner being held to said basket in superposition with said screen by the manual deformation of said foil border around sides of the basket.

7. The lint filtering system of claim 6 wherein said filter basket liner is removably held to said filter basket.

8. The lint filtering system of claim 7 wherein said filter medium is covered with an odorous substance.

9. The filter liner of claim 2 wherein said metal foil border lies along two opposing side edges.

10. The filter liner of claim 2 wherein said metal foil border lies along three side edges.
